(19) United States
(12) Patent Application Publication
(10) Pub. No.: US 2016/0285983 A1
(43) Pub. Date: Sep. 29, 2016

(54) DATA COMMUNICATION METHOD AND DATA COMMUNICATION SYSTEM

(71) Applicant: Huizhou Kimree Technology Co., Ltd., Guangdong (CN)

(72) Inventor: Qiuming Liu, Guangdong (CN)

(21) Appl. No.: 15/174,549

(22) Filed: Jun. 6, 2016

Related U.S. Application Data
(63) Continuation of application No. PCT/CN2014/085505, filed on Aug. 29, 2014.

(51) Int. Cl. H04L 29/08; G06F 17/30; A24F 47/00

(52) U.S. Cl. CPC H04L 67/22; H04L 67/12; A24F 47/002; G06F 17/30522; G06F 17/30554; G06F 17/3056

(57) ABSTRACT

A data communication method and a data communication system are provided according to the disclosure. In the data communication method, the electronic cigarette collects the smoking-related data, and transmits the smoking-related data to the mobile terminal, so that the mobile terminal transmits the smoking-related data to a service platform, and the service platform may perform analysis on the smoking-related data to push corresponding information to the user terminal according to the smoking-related data.

### CROSS-REFERENCES TO RELATED APPLICATIONS

This application is a continuation of PCT/CN2014/085505, filed on Aug. 29, 2014 and titled “DATA COMMUNICATION METHOD AND DATA COMMUNICATION SYSTEM”, which are incorporated herein by reference in their entireties.

### FIELD

The disclosure relates to communication field, in particular to a data communication method and a data communication system.

### BACKGROUND

Electronic cigarette is a new electronic product, which has an appearance and smell similar to that of a conventional cigarette, but is healthy and environmental-friendly for people.

With the increasing number of users of the electronic cigarette, the user wishes to acquire information about various aspects of the electronic cigarette.

In conventional technology, the user can not obtain the personalized information, i.e., the information, corresponding to user habits of using the electronic cigarette and parameters that the electronic cigarette has. Thereby may not effectively push personalized services. In addition, even if the information may be pushed to the user, the information is pushed in a single mode and usage experience of the user is poor.

### SUMMARY

A data communication method and a data communication system are provided according to the disclosure, which may facilitate the electronic cigarette to collect smoking-related data to perform analysis, so that a service platform pushes personalized services according to the smoking-related data in various modes, thereby improving usage experience of the user.

The data communication method includes:

collecting, by an electronic cigarette, smoking-related data;

transmitting, by the electronic cigarette, the smoking-related data to a user terminal bound with the electronic cigarette;

transmitting, by the user terminal, the smoking-related data to a service platform;

storing, by the service platform, the smoking-related data into a database established by the service platform;

obtaining, by the service platform, information corresponding to the smoking-related data through analyzing the smoking-related data;

receiving, by the service platform, request information for an object presentation mode transmitted by the user terminal;

determining, by the service platform, the object presentation mode;

pushing, by the service platform, the information corresponding to the smoking-related data to the user terminal in the object presentation mode; and

presenting, by the user terminal, the information corresponding to the smoking-related data in the object presentation mode.

In the data communication method, the object presentation modes include: a pie chart, a column chart, a trend chart, a three-dimensional diagram, a two-dimensional diagram, a static diagram, a dynamic diagram and a presentation list.

In the data communication method, before receiving, by the service platform, request information for an object presentation mode which is transmitted by the user terminal, the method further includes:

establishing, by the user terminal, a selection list recording presentation modes;

receiving, by the user terminal, a selection operation from a user, to allow the user to select the object presentation mode through the selection operation;

generating, by the user terminal, the request information for the object presentation mode according to the selection operation input by the user; and

transmitting, by the user terminal, the request information for the object presentation mode to the service platform.

The data communication method further includes:

establishing, by the electronic cigarette, an association relationship between the electronic cigarette and the user terminal.

In the data communication method, the electronic cigarette establishes the association relationship with the user terminal through bluetooth, wireless fidelity, infrared or NFC, etc.

In the data communication method, collecting, by the electronic cigarette, smoking-related data includes:

collecting, by the electronic cigarette, an identification for a taste of tobacco tar stored in the electronic cigarette;

or

collecting, by the electronic cigarette, the number of times that the user smokes by using a taste of tobacco tar.

In the data communication method, collecting, by an electronic cigarette, smoking-related data includes:

collecting, by the electronic cigarette, a duration for the user smoking each time;

or

collecting, by the electronic cigarette, a time interval between two adjacent times that the user smokes;

or

collecting, by the electronic cigarette, a period of time when the user smokes;

or

collecting, by the electronic cigarette, a frequency for the user smoking.

In the data communication method, the collecting, by the electronic cigarette, smoking-related data includes:

collecting, by the electronic cigarette, a voltage of a battery inside the electronic cigarette;

or

collecting, by the electronic cigarette, a resistance of an atomizer inside the electronic cigarette, where the atomizer is configured to atomize tobacco tar to generate smoke.

In the data communication method, before transmitting, by the user terminal, the smoking-related data to the service platform, the method further includes:

determining, by the user terminal, whether the smoking-related data satisfies a preset reporting condition; and

triggering the user terminal to transmit the smoking-related data to the service platform, if the smoking-related data satisfies the preset reporting condition.

A data communication system includes an electronic cigarette, a user terminal and a service platform.

The electronic cigarette is configured to collect smoking-related data and transmit the smoking-related data to the user terminal bound with the electronic cigarette;

the user terminal is configured to transmit the smoking-related data to the service platform;

the service platform is configured to store the smoking-related data into a database established by the service platform, obtain information corresponding to the smoking-related data through analyzing the smoking-related data, receive request information for an object presentation mode transmitted by the user terminal, determine the object presentation mode, and push the information corresponding to the smoking-related data to the user terminal in the object presentation mode.

the user terminal is further configured to present the information corresponding to the smoking-related data in the object presentation mode.

In the data communication system, the object presentation modes include: a pie chart, a column chart, a trend chart, a three-dimensional diagram, a two-dimensional diagram, a static diagram, a dynamic diagram and a presentation list.

In the data communication system, the user terminal is further configured to establish a selection list recording presentation modes, receive a selection operation from the user, to allow the user to select the object presentation mode through the selection operation, generate the request information for the object presentation mode according to the selection operation input by the user, and transmit the request information for the object presentation mode to the service platform.

In the data communication system, the electronic cigarette is further configured to establish an association relationship between the electronic cigarette between the user terminal.

In the data communication system, the electronic cigarette establishes the association relationship with the user terminal through bluetooth, WIFI, infrared or NFC.

In the data communication system, the smoking-related data collected by the electronic cigarette includes: an identification for a taste of tobacco tar stored in the electronic cigarette, and the number of times that the user smokes by using a taste of tobacco tar.

In the data communication system, the smoking-related data collected by the electronic cigarette comprises: a duration for the user smoking each time; a time interval between two adjacent times that the user smokes; a period of time when the user smokes; and a frequency for the user smoking.

In the data communication system, the smoking-related data collected by the electronic cigarette includes: a voltage of a battery inside the electronic cigarette, and a resistance of an atomizer inside the electronic cigarette, where the atomizer is configured to atomize tobacco tar to generate smoke.

In the data communication system, the user terminal is further configured to determine whether the smoking-related data satisfies a preset reporting condition, and trigger the user terminal to transmit the smoking-related data to the service platform, if the smoking-related data satisfies the preset reporting condition.

### BRIEF DESCRIPTION OF THE DRAWINGS

FIG. 1 is a flow chart of steps of a data communication method provided according to a preferred embodiment of the disclosure;

FIG. 2 is a flow chart of steps of the data communication method provided according to another preferred embodiment of the disclosure;

FIG. 3 is a schematic diagram of a data communication frame provided according to the disclosure; and

FIG. 4 is a schematic diagram of a data communication system provided according to an embodiment of the disclosure.

### DETAILED DESCRIPTION

A data communication method, in which it can be implemented that a service platform pushes a personalized service to a user, is described in detail according to an embodiment.

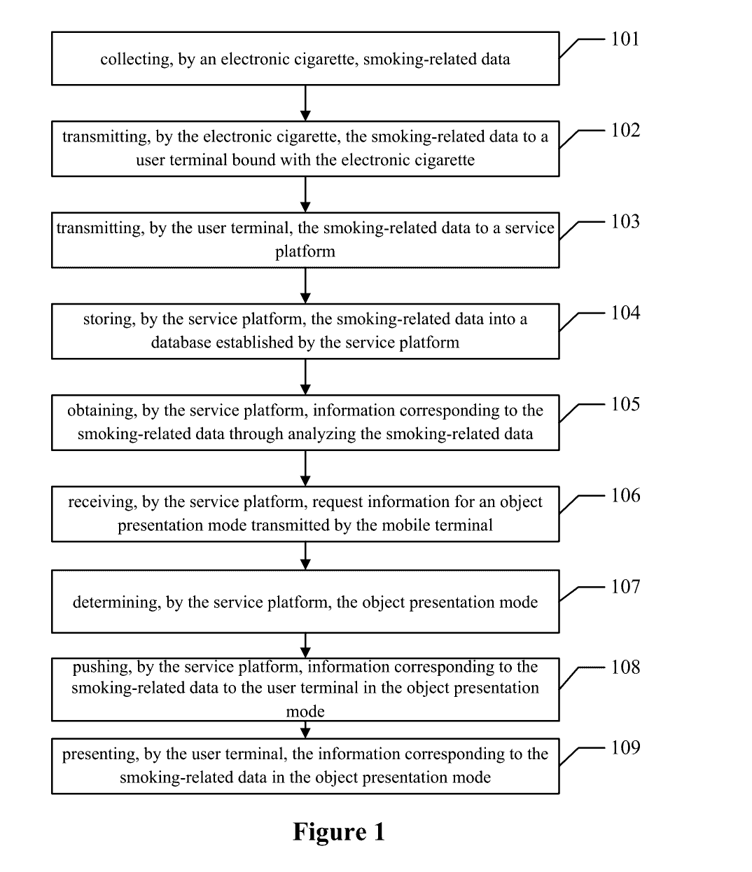

Referring to FIG. 1, which is a flow chart of steps of a data communication method according to an embodiment of the disclosure, the method may include steps 101 to 109.

Step 101 includes: collecting, by an electronic cigarette, smoking-related data.

According to the embodiment, the electronic cigarette collects the smoking-related data of the electronic cigarette.

According to the embodiment, the smoking-related data is not limited.

Step 102 includes: transmitting, by the electronic cigarette, the collected smoking-related data to a mobile terminal bound with the electronic cigarette.

After collecting the smoking-related data, the electronic cigarette may transmit the smoking-related data to the user terminal which is pre-bound with the electronic cigarette.

The user terminal according to the embodiment may be a cellphone, a personal computer, a laptop, a tablet computer or terminals of other types, which are not limited herein.

Step 103 includes: transmitting, by the user terminal, the smoking-related data to a service platform.

After receiving the smoking-related data transmitted by the electronic cigarette, the user terminal may directly transmit the smoking-related data to the service platform.

Step 104 includes: storing, by the service platform, the smoking-related data into a database pre-created by the service platform.

The databases created by the service platform include, but are not limited to, sql server and access of Microsoft, mysql of MYSQL, db2 of IBM, and oracle of Oracle, where access is a small database, sql server and mysql are medium databases, and db2 and oracle are large databases.

According to the embodiment, taking account of an actual need and cost requirement of the data communication method according to the embodiment, the case that the database created by the service platform is a medium database is taken as an example to perform illustration.

In the medium databases, compared with sql server, mysql is characterized in small volume, fast speed and low cost, thus mysql is preferred to perform database development herein. Mysql is taken as an example to illustrate creation of the database and data storage in the following.

First, a database is created,

in Linux shell, mysql is opened (a statement that mysql-u root-p may be input to open mysql)

such as establishing a database named kd:

create databases kd.

Second, a table is created:

use databaseName;
create table tableName (field);
such as creating a table named user with fields including serial number, name and age:
create table use (id int auto_increment not null primary key,name char(10),age int);

Last, data is stored:

insert into user values(“,‘charles’,‘25’).

In this way, a database is created in mysql, and a data table for storing objects is created, thus data storage may be normally performed.

It should be noted that the foregoing way for creating the database is described exemplarily, and is not limited as long as the database which may store date is created on the service platform.

Step 105 includes: obtaining, by the service platform, information corresponding to the smoking-related data through analyzing the smoking-related data.

The service platform analyzes the smoking-related data stored in the database.

A specific way, in which the service platform analyzes the smoking-related data, may include:

performing, by the service platform, a data query, also called data preparation, on the smoking-related data to find out rule of data.

For example, the data query may be performed, as the foregoing data storage, in Linux shell, alternatively, data may be queried in Java environment and imported into a file.

If the data is queried in Linux shell, statements in the following are used.

Designated id items are selected from the data table:

select* from tableName where id= X; and
all items are selected from the data table:
select * from tableName.

If the data is queried in Java environment, statements in the following are used.

First step includes: in the Java environment, establishing connection to a mysql database through java database connectivity (JDBC):

```
  Class.forName(“com.mysql.jdbc.Driver”);
  String user=“root”;
  String password=“”;
  String url=“jdbc:mysql://...:3306/...”;Connection conn=DriverManagergetConnection(url,
user, password); (where the universal resource locator (URL) is an access path of the
database).
```

Second step includes: writing query statements,

one item is queried:

```
Object o=null;
  Statement stmt=conn.createStatement( );
  String sql=“select * from tableName where id=X”;
  ResultSet rs=stmt. executeQuery(sql);
  while(rs.next( )){ o=new Object( ); //data is acquired from rs and is assigned to o through
set}
  return o;
```

all items are queried:

```
  //querying all items
  ArrayList<Object> os=new ArrayList<Object>( );
  Statement stmt=conn.createStatement( );
  String sql=“select * from tableName”;
  ResultSet rs=stmt. executeQuery(sql);
  while(rs.next( )){Object o=new Object( ); //data is acquired form rs, and is assigned to o
os.add(o) through set;}
  return os.
```

The specific way for the data query is exemplarily illustrated in the foregoing, and is not limited.

The service platform seeks a rule of the smoking-related data, i.e. seeks relationship between the smoking-related data and phenomenon, and relationship between data.

Main technology used to seek rule is data mining, i.e., the service platform performs statistical analysis and modeling analysis, of which implementation ways are not limited in the embodiment, on the data.

In general, SPSS, Matlab, Mathmatica, Lindo and Lingo may be used,

where SPSS is normally configured for preliminary analysis to obtain rough data distribution, and the others are often configured for rule verification and numerical analysis.

For example, the service platform may obtain distribution of users of electronic cigarettes through SPSS to determine respective numbers of users in different regions, thereby facilitating the service platform to clearly determine user distribution to accurately allocate marketing effort. For another example, the service platform may determine an age range in which users of electronic cigarette is the most, and the service platform may clearly determine client objects to guide product development. Furthermore, usage habits and preference of one user such as a preferred electronic cigarette, preferred tobacco tar, and smoking frequency may be collected, to accurately push product information.

Last step includes: presenting, by the service platform, the rule of the smoking-related data, i.e., visualizing the rule to facilitate nonprofessionals to use the data.

Step 106 includes: receiving, by the service platform, request information for an object presentation mode transmitted by the mobile terminal.

The mobile terminal determines the object presentation mode in advance, correspondingly generates the request information for the object presentation mode, and transmits the request information for the object presentation mode to the service platform.

Step 107 includes: determining, by the service platform, the object presentation mode.

The service platform establishes corresponding relationships between request information and presentation modes in the database in advance, so that after receiving the request information for the object presentation mode, the service platform may determine the object presentation mode corresponding to the request information based on the corresponding relationship.

The presentation mode is not limited according to the embodiment.

For example, the presentation modes include, but are not limited to: a pie chart, a column chart, a trend chart, a three-dimensional diagram, a two-dimensional diagram, a static diagram, a dynamic diagram and a presentation list.

Step 108 includes: pushing, by the service platform, information corresponding to the smoking-related data to the user terminal in the object presentation mode.

For example, if the object presentation mode selected by the user is the pie chart, the service platform pushes the information corresponding to the smoking-related data in the form of the pie chart to the user terminal.

Specifically, according to the embodiment, the service platform may push corresponding information to the service platform based on the smoking-related data transmitted by the user terminal,

where the information corresponding to the smoking-related data includes, but is not limited to, pushing, by the service platform, advertising information or news to the user terminal, i.e. That is, the service platform may push different information based on different smoking-related data to implement that the service platform pushes personalized services to the user.

Step 109 includes: presenting, by the user terminal, the information corresponding to the smoking-related data through the object presentation mode.

If the object presentation mode selected by the user is the pie chart, the user terminal displays the information corresponding to the smoking-related data through the pie chart.

According to the embodiment, the electronic cigarette collects the smoking-related data, and transmits the smoking-related data to the user terminal, to allow the user terminal to transmit the smoking-related data to the service platform. The service platform may perform analysis on the smoking-related data to push corresponding information to the user terminal based on the smoking-related data. The service platform may push different information according to different smoking-related data. Therefore besides the smoking status of the user himself/herself, the user may know more content may be acquired from the service platform through the user terminal, thereby may implement interaction for more kinds of information, thus improving user experience. The service platform may receive the request information for the object presentation mode which is transmitted by the mobile terminal, so that the mobile terminal may present the information corresponding to the smoking-related data in the object presentation mode. Therefore the information pushed to the mobile terminal by the service platform may be more personally displayed, thus improving user interest and experience during usage.

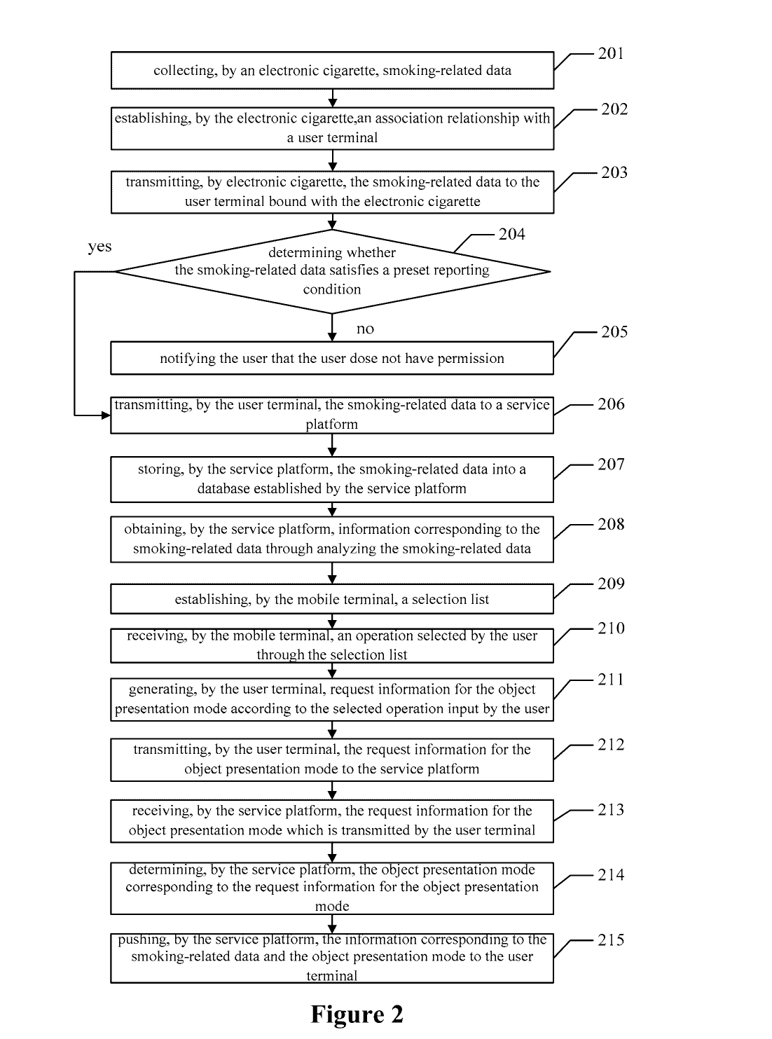

The data communication method is further described in detail in the following with reference to FIG. 2, the method may include steps 201 to 216.

Step 201 includes: collecting, by an electronic cigarette, smoking-related data.

According to the embodiment, a specific way for collecting the smoking-related data by the electronic cigarette may be that the electronic cigarette collects the smoking-related data through a built-in sensor switch of the electronic cigarette.

The structure and principle of the sensor switch are conventional technology, and are not described in the embodiment.

Specifically, the electronic cigarette collects a duration for the user smoking each time. The sensor switch is configured to generate a trigger signal according to an action that the user smokes, to make the electronic cigarette atomizes tobacco tar to generate smoke according to the trigger signal; or the electronic cigarette collects a time interval between two adjacent times that the user smokes through the sensor switch; or the electronic cigarette collects a period of time when the user smokes through the sensor switch; or the electronic cigarette collects a frequency that the user smokes through the sensor switch.

The smoking-related data is exemplarily described according to the embodiment, and is not limited. For example, the smoking-related data may include voltage of a battery inside the electronic cigarette which is collected by the electronic cigarette or resistance of an atomizer inside the electronic cigarette which is collected by the electronic cigarette.

The atomizer is configured to atomize tobacco tar to generate smoke. The specific structure and implementation principle of the atomizer may refer to the conventional technology, and are not described in the embodiment.

For another example, the smoking-related data includes identifications for indicating various tastes of tobacco tar pre-stored in the electronic cigarette which are collected by the electronic cigarette, or numbers of times that the user smokes by using various tastes of tobacco tar which are collected by the electronic cigarette.

Step 202 includes: establishing, by the electronic cigarette, association relationship with a user terminal.

Specifically, the electronic cigarette establishes the association relationship with the user terminal through bluetooth, WIFI, infrared or NFC, etc.

Step 203 includes: transmitting, by electronic cigarette, the collected smoking-related data to the mobile terminal bound with the electronic cigarette.

Step 203 according to the embodiment is the same as step 102 shown in FIG. 1, and is not described according to the embodiment.

Step 204 includes: determining, by the user terminal, whether the smoking-related data satisfies a preset reporting condition, if the smoking-related data satisfies the preset reporting condition, executing step 206, and if the smoking-related data dose not satisfy the preset reporting condition, executing step 205.

The user terminal may preset the reporting condition, which may be set with different standards and is not limited according to the embodiment.

For example, if the smoking-related data is a duration for the user smoking, thus the preset reporting condition may be a preset duration, so that the user terminal determines whether the duration for the user smoking succeeds the preset duration; if the duration for the user smoking succeeds the preset duration, the user terminal determines that the smoking-related data satisfies the preset reporting condition.

If the smoking-related data is a time interval between two adjacent times that the user smokes, the preset reporting condition may be a preset time interval, so that the user terminal determines whether the time interval between two adjacent times that the user smokes succeeds the preset time interval; and if the time interval between two adjacent times that the user smokes succeeds the preset time interval, the user terminal determines that the smoking-related data satisfies the preset reporting condition.

If the smoking-related data is a period of time when the user smokes, the preset reporting condition is a preset period of time, so that the user terminal determines whether the user smokes in the period of the time; and if the period of time when the user smokes is in the preset period of the time, the user terminal determines that the smoking-related data satisfies the preset reporting condition.

If the smoking-related data is a frequency for the user smoking, the preset reporting condition is a preset frequency value, so that the user terminal determines whether the frequency for the user smoking succeeds the preset frequency value; if the frequency for the user smoking succeeds the preset frequency value, the user terminal determines that the smoking-related data satisfies the preset reporting condition.

If the smoking-related data is a voltage of the battery inside the electrode cigarette, the preset reporting condition may be a preset voltage range, so that the user terminal determines whether the voltage of the battery is in the present voltage range; if the voltage of the battery in the preset voltage range, the user terminal determines that the smoking-related data satisfies the preset reporting condition.

If the smoking-related data is a resistance of the atomizer inside the electrode cigarette, the preset reporting condition may be a preset resistance range, so that the user terminal determines whether the resistance of the atomizer is in the present resistance range; if the resistance of the battery in the preset resistance range, the user terminal determines that the smoking-related data satisfies the preset reporting condition.

Step 205 includes: notifying the user that the user dose not have permission to transmit the smoking-related data to a service platform.

According to the embodiment, if the user terminal determines that the smoking-related data does not satisfy the preset reporting condition, the user terminal may generate notification information to notify that the user that the user dose not have the permission to transmit the smoking-related data to the service platform, furthermore the user may be notified how to acquire the permission, which is not limited herein.

206 includes: transmitting, by the user terminal, the smoking-related data to the service platform.

Specifically, the user terminal may transmit trigger signal to the service platform through a mobile communication network, a WIFI network or communication networks of other types.

It should be illustrated that step 204 according to the embodiment is an optional step in practical application. That is, the user terminal may determine whether the smoking-related data satisfies the preset reporting condition; if the smoking-related data satisfies the preset reporting condition, subsequent steps are executed. Alternatively, the subsequent steps may be executed without determining whether the smoking-related data satisfies the preset reporting condition, which is not limited herein.

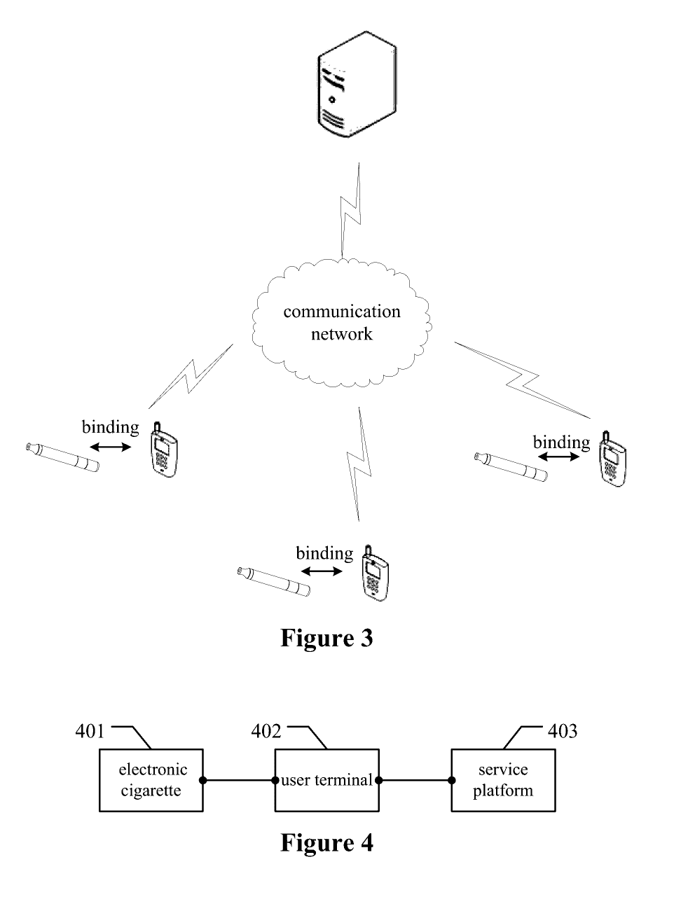

As shown in FIG. 3, which is a structural diagram of a communication system according to the embodiment, the electronic cigarette is bound with the user terminal, the user terminal is connected to the service platform through the communication network, and the service platform may provide service to multiple electronic cigarettes and user terminals.

Step 207 includes: storing, by the service platform, the smoking-related data into a database pre-established by the service platform.

Step 208 includes: obtaining, by the service platform, information corresponding to the smoking-related data through analyzing the smoking-related data.

The implementation processes of step 207 and step 208 according to the embodiment refer to step 104 and step 105 shown in FIG. 1, and are not described in the embodiment.

Step 209 includes: establishing, by the mobile terminal, a selection list.

Where the selection list records presentation modes.

Step 210 includes: receiving, by the user terminal, a selection operation from the user.

The user terminal selects the object presentation mode according to the selection operation input by the user.

Step 211 includes: generating, by the user terminal, request information for the object presentation mode according to the selection operation input by the user.

Step 212 includes: transmitting, by the user terminal, the request information for the object presentation mode to the service platform.

Step 213 includes: receiving, by the service platform, the request information for the object presentation mode which is transmitted by the user terminal.

Step 214 includes: determining, by the service platform, the object presentation mode.

Step 215 includes: pushing, by the service platform, the information corresponding to the smoking-related data to the user terminal in the object presentation mode.

According to the embodiment, the service platform may push advertising information or news, including information about nearby electronic cigarette shops or maintenance knowledge of electronic cigarettes, of which specific forms may be characters, pictures, sounds or videos, to the user terminal.

It should be illustrated that according to the embodiment, if an APP corresponding to the electronic cigarette is installed on the user terminal, the service platform may push information to the APP, and the APP presents the information to the user. If an APP corresponding to the electronic cigarette is not installed on the user terminal, the service platform may also push the information to other original applications (such as a browser, etc) on the user terminal, and the other applications present the information, of which specific ways are not limited.

Step 216 includes: presenting, by the user terminal, the information corresponding to the smoking-related data in the object presentation mode.

The implementation processes of step 213 to step 216 according to the embodiment refer to step 106 to step 109 shown in FIG. 1, and are not described in the embodiment.

According to the embodiment, in a case that the mobile terminal determines that the smoking-related data transmitted by the electronic cigarette satisfies the preset reporting condition, the mobile terminal may transmit the smoking-related data to the service platform, and the service platform may push corresponding information according to the smoking-related data. The service platform may push different information according to different smoking-related data. Therefore besides the smoking status of the user himself/herself, the user may learn more content from the service platform through the user terminal, thereby may implement interaction for more kinds of information, thus improving user experience. Furthermore, according to the embodiment, only if the preset reporting condition is satisfied, the mobile terminal may receive the information pushed by the service platform, thereby reducing burden of the service platform.

The data communication method according to the embodiment of the disclosure is described in the foregoing, and a communication system according to an embodiment of the disclosure is described in the following. Referring to FIG. 4, the communication system according to the embodiment of the disclosure includes: an electronic cigarette 401, a user terminal 402 and a service platform 403.

The electronic cigarette 401 is configured to collect smoking-related data.

According to the embodiment, the electronic cigarette 401 collects the smoking-related data of the electronic cigarette.

The electronic cigarette 401 is configured to transmit the collected smoking-related data to a mobile terminal bound with the electronic cigarette 401.

After collecting the smoking-related data, the electronic cigarette 401 may transmit the smoking-related data to the user terminal 402 which is pre-bound with the electronic cigarette 401.

The user terminal 402 according to the embodiment may is a cellphone, a personal computer, a laptop, a tablet computer or terminals of other types, which are not limited herein.

The user terminal 402 is configured to transmit the smoking-related data to the service platform 403.

After receiving the smoking-related data transmitted by the electronic cigarette 401, the user terminal 402 may directly transmit the smoking-related data to the service platform 403.

The service platform 403 is configured to store the smoking-related data into a database pre-created by the service platform.

The databases created by the service platform 403 include, but are not limited to, sql server and access of Microsoft, mysql of MYSQL, db2 of IBM, and oracle of Oracle, where access is a small database, sql server and mysql are medium databases, and db2 and oracle are large databases.

According to the embodiment, taking account of an actual need and cost requirement of the data communication method according to the embodiment, the case that the database created by the service platform 403 is a medium database is taken as an example to perform illustration.

In the medium databases, compared with sql server, mysql is characterized in small volume, fast speed and low cost, thus it is preferred to perform database development in Mysql. Mysql is taken as an example to illustrate creation of the database and data storage in the following.

First, a database is created,

in Linux shell, mysql is opened (a statement that mysql-u root-p may be input to open mysql)

such as creating a database named kd:

create databases kd.

Second, a table is established:

use databaseName;
create table tableName (field);
such as creating a table named user with fields including serial number, name and age:
create table use(id int auto_increment not null primary key, name char(10), age int);

Last, data is stored:

insert into user values(“,‘charles’,‘25’).

In this way, a database is created in mysql, and a data table for storing objects is created, thus data storage may be normally performed.

It should be noted that the foregoing way for creating the database is described exemplarily, and is not limited as long as the database which may store date is created on the service platform 403.

The service platform 403 is configured to obtain information corresponding to the smoking-related data through analyzing the smoking-related data.

The service platform 403 analyzes the smoking-related data stored in the database.

A specific way, in which the service platform 403 analyzes the smoking-related data, may include:

performing, by the service platform 403, a data query, called data preparation, on the smoking-related data to find out rule of data.

For example, the data query may be performed, as the foregoing data storage, in Linux shell, alternatively, data may be queried in Java environment and imported into a file.

If the data is queried in Linux shell, statements in the following are used.

Designated id items are selected from the data table:

select* from tableName where id= X; and
all items are selected from the data table:
select * from tableName.

If the data is queried in Java environment, statements in the following are used.

First step includes: in the Java environment, establishing connection to a mysql database through java database connectivity (JDBC):

```
  Class.forName(“com.mysql.jdbc.Driver”);
  String user=“root”;
  String password=“”;
  String url=“jdbc:mysql://...:3306/...”;Connection conn=DriverManagergetConnection(url,
user, password); (where universal resource locator (URL) is an access path of the database).
```

Second step includes: writing query statements,

one item is queried:

```
  Object o=null;
  Statement stmt=conn.createStatement( );
  String sql=“select * from tableName where id=X”;
  ResultSet rs=stmt. executeQuery(sql);
  while(rs.next( )){o=new Object( ); //data is acquired from rs and is assigned to o through
set}
  return o;
```

all items are queried:

```
  //finding out all items
  ArrayList<Object> os=new ArrayList<Object>( );
  Statement stmt=conn.createStatement( );
  String sql=“select * from tableName”;
  ResultSet rs=stmt. executeQuery(sql);
  while(rs.next( )){0bject o=new Object( ); //data is acquired form rs, and is assigned to o
os.add(o) through set;}
  return os.
```

The specific way for the data query is exemplarily illustrated in the foregoing, and is not limited.

The service platform 403 seeks a rule of the smoking-related data, i.e. seeks relationship between the smoking-related data and phenomenon, and relationship between data.

Main technology used to seek rule is data mining, i.e., the service platform 403 performs statistical analysis and modeling analysis, etc, of which implementation ways are not limited in the embodiment, on the data.

In general, SPSS, Matlab, Mathmatica, Lindo and Lingo may be used,

where SPSS is normally configured for preliminary analysis to obtain rough data distribution, the others are often configured for rule verification and numerical analysis.

For example, the service platform 403 may obtain distribution of users using the electronic cigarette 401 through SPSS to determine respective numbers of users in different regions, thereby facilitating the service platform 403 to clearly determine user distribution to accurately allocate marketing effort. For another example, the service platform 403 may determine an age range in which users of electronic cigarette is the most, and the service platform 403 may clearly determine client objects to guide product development. Furthermore, usage habits and preference of one user such as preferred electronic cigarettes 401, preferred tobacco tar, and smoking frequency, may be collected to accurately push product information.

Last step includes: presenting, by the service platform 403, the rule of the smoking-related data, i.e., visualizing the rule to facilitate nonprofessionals to use the data.

The service platform 403 is configured to receive request information for an object presentation mode transmitted by the mobile terminal.

The mobile terminal determines the object presentation mode in advance, correspondingly generates the request information for the object presentation mode, and transmits the request information for the object presentation mode to the service platform 403.

The service platform 403 is configured to determine the object presentation mode.

The service platform 403 establishes corresponding relationships between request information and presentation modes in the database in advance, so that after receiving the request information for the object presentation mode, the service platform 403 determines the object presentation mode corresponding to the request information according to the corresponding relationship.

The presentation mode is not limited according to the embodiment.

For example, the presentation modes include, but are not limited to: a pie chart, a column chart, a trend chart, a three-dimensional diagram, a two-dimensional diagram, a static diagram, a dynamic diagram and a presentation list.

The service platform 403 is configured to push information corresponding to the smoking-related data to the user terminal 402 in the object presentation mode.

For example, if the object presentation mode selected by the user is the pie chart, the service platform 403 pushes the information corresponding to the smoking-related data in the form of the pie chart to the user terminal 402.

Specifically, according to the embodiment, the service platform 403 may push corresponding information to the service platform 402 based on the smoking-related data transmitted by the user terminal 402,

where the information corresponding to the smoking-related data includes, but is not limited to, pushing, by the service platform 403, advertising information or news content to the user terminal 402. That is, the service platform 403 may push different information based on different smoking-related data to implement that the service platform 403 pushes personalized services to the user.

The user terminal 402 is configured to present the information corresponding to the smoking-related data through the object presentation mode.

If the object presentation mode selected by the user is the pie chart, the user terminal 402 displays the information corresponding to the smoking-related data through the pie chart.

According to the embodiment, the electronic cigarette 401 collects the smoking-related data, and transmits the smoking-related data to the mobile terminal, to allow the user terminal to transmit the smoking-related data to the service platform 403. The service platform 403 may perform analysis on the smoking-related data to push corresponding information to the user terminal 402 based on the smoking-related data. The service platform 403 may push different information according to different smoking-related data. Therefore besides the smoking status of the user himself/herself, the user may know more content may be acquired from the service platform 403 through the user terminal 402, thereby may implement interaction for more kinds of information, thus improving user experience. The service platform 403 may receive the request information for the object presentation mode which is transmitted by the mobile terminal, so that the mobile terminal may present the information corresponding to the smoking-related data in the object presentation mode. Therefore the information pushed to the mobile terminal by the service platform 403 may be more personally displayed, thus improving user interest and experience during usage.

Referring to FIG. 4, the data communication system is further described in the following.

The electronic cigarette 401 is configured to collect smoking-related data.

According to the embodiment, a specific way for collecting the smoking-related data by the electronic cigarette 401 may be that the electronic cigarette 401 collects the smoking-related data through a built-in sensor switch of the electronic cigarette 401.

The structure and principle of the sensor switch are conventional technology, and are not described in the embodiment.

Specifically, the electronic cigarette collects a duration for the user smoking each time. The sensor switch is configured to generate trigger signal according to an action that the user smokes, to make the electronic cigarette 401 atomizes tobacco bar to generate smoke according to the trigger signal; or the electronic cigarette 401 collects a time interval between two adjacent times that the user smokes through the sensor switch; or the electronic cigarette collects a period of time when the user smokes through the sensor switch; or the electronic cigarette collects a frequency that the user smokes through the sensor switch.

The smoking-related data is exemplarily described according to the embodiment, and is not limited. For example, the smoking-related data may include voltage of a battery inside the electronic cigarette 401 which is collected by the electronic cigarette 401 or resistance of an atomizer inside the electronic cigarette 401 which is collected by the electronic cigarette 401.

The atomizer is configured to atomize tobacco tar to generate smoke. The structure and principle of the atomizer may refer to conventional technology, and are not described in the embodiment.

For another example, the smoking-related data includes identifications for indicating various tastes of tobacco tar pre-stored in the electronic cigarette 401 which are collected by the electronic cigarette 401, or numbers of times that the user smokes by using various tastes of tobacco tar which are collected by the electronic cigarette 401.

The electronic cigarette 401 is configured to establish association relationship with the user terminal 402.

Specifically, the electronic cigarette 401 establishes the association relationship with the user terminal 402 through bluetooth, WIFI, infrared or NFC, etc.

The electronic cigarette 401 is configured to transmit the collected smoking-related data to a mobile terminal bound with the electronic cigarette 401.

The user terminal 402 is configured to determine whether the smoking-related data satisfies a preset reporting condition.

The user terminal 402 may preset the reporting condition which may be set with different standards and is not limited according to the embodiment.

For example, if the smoking-related data is a duration for the user smoking, thus the reporting condition may be a preset duration, so that the user terminal determines whether the duration for the user smoking succeeds the preset duration; if the duration for the user smoking succeeds the preset duration, the user terminal determines that the smoking-related data satisfies the preset reporting condition.

If the smoking-related data is a time interval between two adjacent times that the user smokes, the reporting condition may be a preset time interval, so that the user terminal determines whether the time interval between two adjacent times that the user smokes succeeds the preset time interval; and if the time interval between two adjacent times that the user smokes succeeds the preset time interval, the user terminal determines that the smoking-related data satisfies the preset reporting condition.

If the smoking-related data is a period of time when the user smokes, the preset reporting condition is a preset period of time, so that the user terminal determines whether the user smokes is in the period of the time; and if the period of time when the user smokes is in the preset period of the time, the user terminal determines that the smoking-related data satisfies the preset reporting condition.

If the smoking-related data is a frequency for the user smoking, the preset reporting condition is a preset frequency value, so that the user terminal determines whether the frequency for the user smoking succeeds the preset frequency value; if the frequency for the user smoking succeeds the preset frequency value, the user terminal determines that the smoking-related data satisfies the preset reporting condition.

If the smoking-related data is a voltage of the battery inside the electronic cigarette, the preset reporting condition may be a preset voltage range, so that the user terminal determines whether the voltage of the battery is in the present voltage range; if the voltage of the battery in the preset voltage range, the user terminal determines that the smoking-related data satisfies the preset reporting condition.

If the smoking-related data is a resistance of the atomizer inside the electrode cigarette, the preset reporting condition may be a preset resistance range, so that the user terminal determines whether the resistance of the atomizer is in the present resistance range; if the resistance of the battery in the preset resistance range, the user terminal determines that the smoking-related data satisfies the preset reporting condition.

In a case that the user terminal 402 determines that the smoking-related data does not satisfy the preset reporting condition, the user terminal 402 is configured to notify the user that the user dose not have permission to transmit the smoking-related data to the service platform 403.

According to the embodiment, if the user terminal 402 determines that the smoking-related data does not satisfy the preset reporting condition, the user terminal may generate notification information to notify that the user that the user dose not have the permission to transmit the smoking-related data to the service platform, furthermore the user may be notified how to acquire the permission, which is not limited herein.

The user terminal 402 is configured to transmit the smoking-related data to the service platform 403.

Specifically, the user terminal 402 may transmit the trigger signal to the service platform 403 through a mobile communication network, a WIFI network or communication networks of other types.

As shown in FIG. 3, which is a structural diagram of a communication system according to the embodiment, the electronic cigarette 401 is bound with the user terminal 402, the user terminal 402 is connected to the service platform 403 data through the communication network, and the service platform 403 may provide services to multiple electronic cigarettes 401 and the user terminals 402.

The service platform 403 is configured to store the smoking-related data into a database pre-established by the service platform.

The service platform 403 is configured to obtain information corresponding to the smoking-related data through analyzing the smoking-related data.

The mobile terminal is configured to establish a selection list.

Where the selection list records presentation modes.

The user terminal 402 is configured to receive a selection operation from the user.

The user terminal 402 selects the object presentation mode according to the selection operation input by the user.

The user terminal 402 is configured to generate request information for the object presentation mode according to the selection operation input by the user.

The user terminal 402 is configured to transmit the request information for the object presentation mode to the service platform.

The service platform 403 is configured to receive the request information for the object presentation mode which is transmitted by the user terminal 402.

The service platform 403 is configured to determine the object presentation mode.

The service platform 403 is configured to push information corresponding to the smoking-related data to the user terminal 402 in the object presentation mode.

According to the embodiment, the service platform 403 may push advertising information or news, including information about nearby electronic cigarette 401 shops or maintenance knowledge of electronic cigarettes, of which specific forms may be characters, pictures, sounds or videos, to the user terminal 402.

It should be illustrated that according to the embodiment, if an APP corresponding to the electronic cigarette 401 is installed on the user terminal 402, the service platform 403 may push information to the APP, and the APP presents the information to the user. If an APP corresponding to the electronic cigarette is not installed on the user terminal 402, the service platform 403 may also push the information to other original applications (such as a browser, etc) on the user terminal 402, and the other applications present the information, of which specific ways are not limited.

The user terminal 402 is configured to present the information corresponding to the smoking-related data in the object presentation mode.

According to the embodiment, in a case that the user terminal 402 determines that the smoking-related data transmitted by the electronic cigarette 401 satisfies the preset reporting condition, the user terminal 402 may transmit the smoking-related data to the service platform 403, and the service platform 403 may push corresponding information to the user terminal 402 according to the smoking-related data. The service platform 403 may push different information according to different smoking-related data. Therefore besides the smoking status of the user himself/herself, the user may learn more content from the service platform 403 through the user terminal 402, thereby may implement interaction for more kinds of information, thus improving user experience. Furthermore, according to the embodiment, only if the preset reporting condition is satisfied, the mobile terminal may receive the information pushed by the service platform 403, thereby reducing burden of the service platform 403.

The person of skill in the art may clearly understand that for convenient and simple description, specific operating processes of the foregoing described system, device and unit may refer to corresponding processes according to the method embodiments of the disclosure, and are not described herein.

The above embodiments are only used to illustrate the technical solutions and are not meant to limit the technical solutions. Though the disclosure is described in detail with reference to the foregoing embodiments, it should be understood for person of skill in the art that modifications may be made to the technical solutions according to the embodiments, or equivalent replacements may be made to part of the technical features, and with these modifications or replacements, the basic idea for corresponding technical solutions does not depart from the spirit and the scope of the technical solutions according to the embodiment of the disclosure.

1. A data communication method, comprising:
collecting, by an electronic cigarette, smoking-related data;
transmitting, by the electronic cigarette, the smoking-related data to a user terminal bound with the electronic cigarette;
transmitting, by the user terminal, the smoking-related data to a service platform;
storing, by the service platform, the smoking-related data into a database established by the service platform;
obtaining, by the service platform, information corresponding to the smoking-related data through analyzing the smoking-related data;
receiving, by the service platform, request information for an object presentation mode transmitted by the user terminal;
determining, by the service platform, the object presentation mode;
pushing, by the service platform, information corresponding to the smoking-related data to the user terminal in the object presentation mode to; and
presenting, by the user terminal, the information corresponding to the smoking-related data in the object presentation mode.

2. The data communication method according to claim 1, wherein the object presentation modes comprise: a pie chart, a column chart, a trend chart, a three-dimensional diagram, a two-dimensional diagram, a static diagram, a dynamic diagram and a presentation list.

3. The data communication method according to claim 2, wherein before receiving, by the service platform, request information for an object presentation mode transmitted by the user terminal, the method further comprises:
establishing, by the user terminal, a selection list recording presentation modes;
receiving, by the user terminal, a selection operation from a user, to allow the user to select the object presentation mode through the selection operation;
generating, by the user terminal, the request information for the object presentation mode according to the selection operation input by the user; and
transmitting, by the user terminal, the request information for the object presentation mode to the service platform.

4. The data communication method according to claim 1, further comprising:
establishing, by the electronic cigarette, an association relationship between the electronic cigarette and the user terminal.

5. The data communication method according to claim 4, wherein the electronic cigarette establishes the association relationship with the user terminal through bluetooth, WIFI, infrared or NFC.

6. The data communication method according to claim 1, wherein collecting, by an electronic cigarette, smoking-related data comprises:
collecting, by the electronic cigarette, an identifications for a taste of tobacco tar stored in the electronic cigarette;
or
collecting, by the electronic cigarette, the number of times that the user smokes by using a taste of tobacco tar.

7. The data communication method according to claim 1, wherein collecting, by an electronic cigarette, smoking-related data comprises:
collecting, by the electronic cigarette, a duration for the user smoking each time;
or
collecting, by the electronic cigarette, a time interval between two adjacent times that the user smokes;
or
collecting, by the electronic cigarette, a period of time when the user smokes;
or
collecting, by the electronic cigarette, a frequency for the user smoking.

8. The data communication method according to claim 1, wherein collecting, by an electronic cigarette, smoking-related data comprises:
collecting, by the electronic cigarette, a voltage of a battery inside the electronic cigarette;
or
collecting, by the electronic cigarette, a resistance of an atomizer inside the electronic cigarette, wherein the atomizer is configured to atomize tobacco tar to generate smoke.

9. The data communication method according to claim 1, wherein before transmitting, by the user terminal, the smoking-related data to a service platform, the method further comprises:
determining, by the user terminal, whether the smoking-related data satisfies a preset reporting condition;
triggering the user terminal to transmit the smoking-related data to the service platform, if the smoking-related data satisfies the preset reporting condition.

10. A data communication system, comprising an electronic cigarette, a user terminal and a service platform;
the electronic cigarette is configured to collect smoking-related data and transmit the collected smoking-related data to a user terminal bound with the electronic cigarette;
the user terminal is configured to transmit the smoking-related data to the service platform;
the service platform is configured to store the smoking-related data into a database established by the service platform, obtain information corresponding to the smoking-related data through analyzing the smoking-related data, receive request information for an object presentation mode transmitted by the user terminal, determine the object presentation mode, and push the information corresponding to the smoking-related data to the user terminal in the object presentation mode; and
the user terminal is further configured to present the information corresponding to the smoking-related data in the object presentation mode.

11. The data communication system according to claim 10, wherein the object presentation modes comprises: a pie chart, a column chart, a trend chart, a three-dimensional diagram, a two-dimensional diagram, a static diagram, a dynamic diagram and a presentation list.

12. The data communication system according to claim 11, wherein the user terminal is further configured to establish a selection list recording presentation modes, receive a selection operation from a user, to allow the user to select the object presentation mode through the selection operation, generate the request information for the object presentation mode according to the selection operation input by the user, and transmit the request information for the object presentation mode to the service platform.

13. The data communication system according to claim 10, wherein the electronic cigarette is further configured to establish an association relationship between the electronic cigarette and the user terminal.

14. The data communication system according to claim 13, wherein the electronic cigarette establishes the association relationship with the user terminal through bluetooth, WIFI, infrared or NFC.

15. The data communication system according to claim 10, wherein the smoking-related data collected by the electronic cigarette comprises: an identification for a taste of tobacco tar stored in the electronic cigarette, and the numbers of times that the user smokes by using a taste of tobacco tar.

16. The data communication system according to claim 10, wherein the smoking-related data collected by the electronic cigarette comprises: a duration for the user smoking each time, a time interval between two adjacent times that the user smokes, a period of time when the user smokes and a frequency for the user smoking.

17. The data communication system according to claim 10, wherein the smoking-related data collected by the electronic cigarette comprises: a voltage of a battery inside the electronic cigarette, and a resistance of an atomizer inside the electronic cigarette, wherein the atomizer is configured to atomize tobacco tar to generate smoke.

18. The data communication system according to claim 10, wherein the user terminal is further configured to determine whether the smoking-related data satisfies a preset reporting condition, and trigger the user terminal to transmit the smoking-related data to the service platform, if the smoking-related data satisfies the preset reporting condition.
